(19) United States
(12) Patent Application Publication
(10) Pub. No.: US 2010/0034522 A1
(43) Pub. Date: Feb. 11, 2010

(54) System and Method for Providing Digital Content

(75) Inventors: Sheau Ng, Wayland, MA (US); Glenn Reitmeier, Yardley, PA (US)

Correspondence Address: FLETCHER YODER P.C., 7915 FM 1960 RD. WEST, SUITE 330, HOUSTON, TX, 77070, US

(73) Assignee: NBC Universal, Inc., a New York Corporation, New York, NY (US)

(21) Appl. No.: 12/188,862

(22) Filed: Aug. 8, 2008

(51) Int. Cl. H04N 7/26

(52) U.S. Cl. 386/124; 386/E05.001

(57) ABSTRACT

A method and device for receiving, storing, and viewing digital content, the method and device configured to receive and store a first content and a second content, associate the second content with the first content, and play the first content and the second content.

### BACKGROUND

The present invention relates generally to the field of providing digital content, and more particularly to interactive storage for non-linear television content.

Many systems have been developed and are currently in use for providing digital content, such as movies, music, videos, text, and so forth. Such digital content may be supplied by a provider or holder (a supplier) of the content to a distributor or to the consumer, for example. There is an on-going need to more efficiently provide and distribute such content, and to increase the ease at which the consumer or user accesses and views the content. Moreover, there is a desire in the industry to provide digital content via more productive business models.

### BRIEF DESCRIPTION

An aspect of the invention provides a device for receiving, storing, and viewing digital content, the device including an interface for coupling digitally to a host device, and a memory configured to receive and store a first content separate from a second content interact with the host device, associate the second content with the first content, and play the first content and the second content.

An aspect of the invention provides a device for receiving, storing, and viewing digital content, the device including a memory, a system architecture stored in memory, and an interface for coupling digitally to a host device, wherein the system architecture configures the memory to receive and store a first content separate from a second content, associate playback of the second content with playback of the first content, and facilitate playback of the first content and the second content for viewing at the host device.

An aspect of the invention provides a device for receiving, storing, and organizing digital content, the device including: a memory and an interface for coupling digitally to a host device; a first program code stored in the memory, wherein the first program code organizes receipt and storage in the memory of a first digital content and a second digital content, and organizes playback of the first digital content and the second digital content; a second program code stored in memory to facilitate interaction of the device with the host device; and a third program code stored in memory to play back the first digital content and the second digital content for viewing at the host device.

An aspect of the invention provides a method for disseminating digital content, including transmitting a first content and a second content via a host device to a memory, storing the first content and the second content in the memory, associating via executable code stored in the memory playback of the second content with playback of the first content, facilitating via executable code stored in the memory playback of the first content and the second content for viewing at the host device, and updating the first content stored in memory or the second content stored in the memory, or a combination thereof.

An aspect of the invention provides a method for disseminating digital content, including: providing a first content into a first partion of a memory device; providing a second content into a second partition of the memory device, wherein the memory device is configured to facilitate playback of the first content and of the second content at one or more host devices; associating the second content with the first content; monitoring via executable code stored in the memory device a playback history of the first content and of the second content at the one or more host devices; and changing the association of the second content with the first content.

An aspect of the invention provides a device for viewing digital content, including an interface to receive digital content, and a memory configured to organize and store a first content separate from a second content, associate the second content with the first content, and organize and store updates of the first content and of the second content.

An aspect of the invention provides a method for disseminating digital content, including: transmitting a first content and a second content; storing the first content and the second content in memory; associating via executable code stored in the memory playback of the second content with playback of the first content; playing via executable code stored in the memory the first content and the second content, wherein the first content is viewed with the second content based on the association; and updating at least the first content or the second content stored in memory.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of a digital content device in accordance with aspects of the present invention;

FIG. 2 is a block flow diagram of a method of providing digital content in accordance with aspects of the present invention;

FIG. 3 is a diagrammatical representation of the digital content device of FIG. 1 configured to couple to a plurality of host devices in accordance with aspects of the present invention; and

FIG. 4 is a diagrammatical representation of a plurality of host devices having memory for storing digital content in accordance with aspects of the present invention.

### DETAILED DESCRIPTION

In society, the television (TV) experience is being ported from the living-room environment to a multitude of playback devices at and sourced from a variety of locations. As the TV content distribution evolves, the need for ubiquitous TV content follows. Yet, the business model of commercial TV, namely ad-supported free-to-consumer TV programs, generally is not extended easily with technology and services of the past. Paradigm shifts taking root over the past decade include the time and place shifting of viewing content via a digital video recorder (DVR) or personal video recorder (PVR), for example, as well as with the delivery of TV content via cable channels or non-TV broadcast, such as via the internet, mobile phones, and so on.

It should be noted that with traditional personal recording of TV shows and movies, the playback experience of the user is often divorced from the TV service provider. For instance, users can skip over advertisements. Likewise, the service and content providers generally have not been able to effectively monetize this mode of content consumption because the advertisements are not viewed within a known time window. This mode complicates the advertisement impression count. Moreover, where online TV content is streamed, rather than downloaded, users are not able to view the content offline. Even if online TV content is downloaded for offline consumption, audience measurement and advertisement impression tracking are generally lacking and which may be important in an advertisement-supported business model.

In contrast, the present technique works to bridge the gap between a successful business model of ad-supported “free” broadcast TV services with that of ubiquitous access where linear TV rules may no longer apply. The present technique may expand upon current TV business models, facilitating content providers and service providers to monetize the user's consumption of the content when and where the content is viewed. Beneficially, the technique may provide different advertisements to viewers even when the viewers are watching content previously stored on the device. In this regard, the technique may provide for individualized, syndicated “re-runs” of particular shows or episodes, while rewarding the content owners by making different advertisement impressions each time the content is viewed. Furthermore, the technique, as discussed below, may free the user from format conversion due to device incompatibility, for example. Moreover, unique syndication features may be provided. For instance, in certain embodiments, users can subscribe to desired TV shows, and these shows update over time without the user having to download each episode individually.

However, it should be emphasized that while at times, the present discussion may focus on TV, TV shows or episodes, movies, and the like, the present technique is not limited to the delivery and viewing of TV content but may incorporate a variety of digital content in different formats. Moreover, as those skilled in the art will recognize, in the entertainment industry, certain entities will generally generate, create, or receive content, while these or other entities will distribute, sell, or otherwise provide the content to users. Throughout the present discussion, reference will be made to various entities, such as service providers, users, end-users, consumers, and so on. However, in the present context, any or even all of these should be understood to be any person or entity that transmits or receives digital content. Moreover, it is not necessary for a content source to own the intellectual property rights relating to such content.

The present technique accommodates a supplier or distributor to offer digital content to an end-user (e.g., customer or consumer). Digital content is provided to a memory-based device. The memory-based device, which may incorporate solid-state or flash memory, hard disk memory, random access memory (RAM), and so on, receives and stores the digital content. The digital content may include audio/video, such as episodic television (TV) shows, commercial video clips, movies, and so on. As discussed below, in addition to TV show and movie content, the memory of the device may be organized to contain a collection of advertisement content, including audio-visual elements and metadata such as URLs, phone numbers, internet links, and so forth. The technique provides unique approaches and structures regarding loading of content (e.g., video and advertisements) onto the device, playback and playback control of the content, and the reporting of the usage information to the service or content providers. In certain embodiments, the memory-based device may generally be removable and thus can move from one host device to another. Host devices may include a mobile phone, TV receiver or set-top box, personal computer, and the like.

Content may reach the memory-based device via traditional digital TV broadcast, terrestrial data broadcasts, digital cable, the internet, and so on. As content is played back, new advertisements may be pulled from the device's internal advertisement inventory. Thus, new advertisement impressions may be made even if users watch the same content multiple times. Therefore, the present technique enables further monetization of the content. In one example, a new service can be designed allowing users to subscribe to TV shows, which may be updated along with the advertisement inventory. Moreover, usage statistics may be reported back to the service facilitating personalization of advertisements and/or video content. Thus, the technique provides for a connection of the service provider with the consumer, monitoring of usage history, more effective monetization of digital content including non-linear TV content, for example, and so on.

The memory-based device may have a file system organized to separate advertisements from the user-desired content, such as TV shows and movies. Similarly, a separable download mechanism may be employed for the user-desired content versus advertisements. In addition, common application program interfaces (APIs) facilitate in-memory code access to host resources. Further, in-memory executable player codes which are substantially secure may be provided.

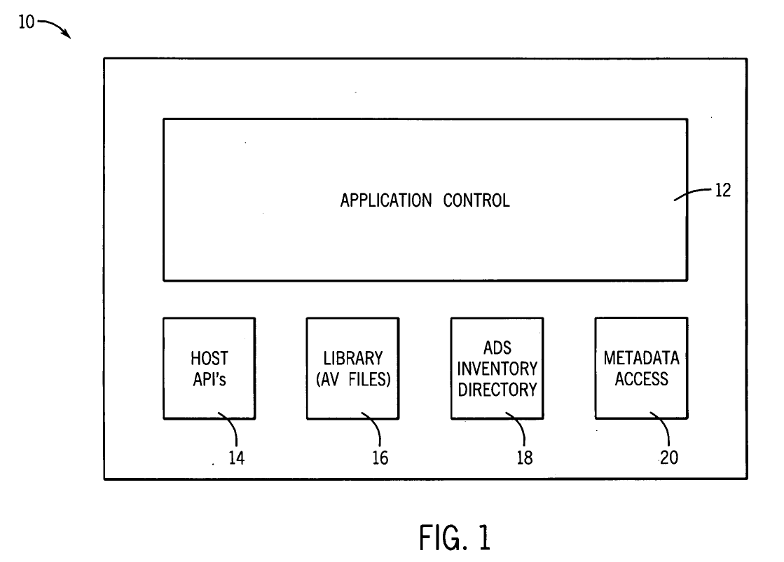

Referring to the drawings, FIG. 1 depicts a digital content device 10, such as a memory device, having system architecture for receiving, storing, and organizing digital content. The digital content stored in device 10 may be ultimately provided or viewed by an end-user at a host device. The device 10 is generally a removable memory-based device and may be digitally coupled to a host device, functioning as an extension of the memory of the host device. The host device may facilitate transmission of digital content to the device 10, as well as provide for viewing the digital content from device 10. Again, exemplary host devices include TVs, TV receivers, TV set-top boxes, cable boxes, personal computers, mobile phones, and so forth. The memory of device 10 may include solid-state memory, flash memory, and/or other memory. Where solid-state or flash memory is employed, in-memory execution of code, such as player software code, is facilitated. In one embodiment, the memory architecture is a solid-state electronic memory of at least 16 gigabytes (GB).

The memory of device 10 in FIG. 1 may store a variety executable code and digital content. For example, the device 10 may include an application control module 12 having code to manage the device. The module 12 may also include one or more application program interfaces (APIs), such as a media player, for playing or playback of audio/video files and the like. The memory of device 10 may also receive and store host APIs 14 associated with a variety of different types of host devices. The host APIs 14 may be pre-loaded into the device 10 during the initial manufacture of the device 10. On the other hand, in certain embodiments, it is contemplated that the host API's 14 may be updated or loaded later after use of the device where compatible or configurable.

It should be noted that as solid-state memory devices and other memory devices gain acceptance by electronics manufactures (e.g. of consumer electronics equipment, mobile/handheld devices, and the like), the digital or physical interconnect of the memory with the equipment is becoming more universal. Leveraging existing industry standards, such as Open cable Application Protocol (OCAP), Advanced Common Application Platform (ACAP), Blu-Ray Java (BRJ), and so forth, to provide beneficial software and middleware application program interface (APIs), the digital content device 10 may place the content player software along with the content inside a single memory device. Typical host resources that may be utilized by the loaded player software include audiovisual rendering capability (e.g., displays and speakers/earphones), general computational resources (CPU), timer/wall clocks, and user input (key presses) events, and so on.

The device 10 also includes a library 16 of audio/video content, such as TV episodes, movies, clips, sporting-event video, news-event video, and so on, stored in memory for viewing by the user. The library 16 may store files of the audio/video content desired by the user. It is generally advantageous that such content be updatable, either automatically or via request by the user, for example. Such content may be updated via a host device.

It should be noted that due to the increasing capacity and high-speed interconnect of flash memory devices (e.g., USB, SD Card, etc.) and non-flash memory devices, embodiments of the present technique employing such memory may provide for receiving and storing a significant amount of digital content, such as multiple episodes of TV shows and/or movies, via a single memory device. Yet, advantageously, because of the small form factor of flash memory, devices 10 employing such flash memory may be generally easily removable and therefore highly portable. In one example, the device 10 incorporates a Universal System Bus (USB) thumb memory stick. In another example, the device 10 incorporates a flash memory card, e.g., Secured Digital (SD) Card. In yet another example, the device 10 incorporates a fast high-density hard drive.

The system architecture of device 10 also provides for the memory to store an advertisement inventory directory (AID) 18 which is also generally updatable. Content may be ingested into both the library 16 and AID 18 via application code resident and executable on the memory of device 10. In one example, the code enables both authored formats with chapter structures organized as a playlist (e.g. DVD-like), as well as linear broadcast formats with advertisement insertion triggers and advertisement replacement functionality. Moreover, ingestion of the content library 16 and AID 18 may be facilitated via a host device and the host APIs 14 resident and executable on the digital content device 10. As mentioned, the host APIs 14 can be excerpted from several industry standards. While not required for implementation of the present technique, it is believed that for certain embodiments, an industry group may standardize on a common set of such APIs 14.

Also, in embodiments, the primary content (e.g., TV show) to be viewed by the user will have advertisement insertion points. Player software resident on the device 10 will rely on these advertisement points to switch from the primary content (e.g., TV program) to secondary content (e.g., one or more of the advertisements) from the AID 18. The player software may also keep track of which audio and which video assets have been played. In certain examples, the organization of such data employ functions of advertisement-supported internet video, but with such functions resident and executable in memory of the digital content device 10.

There are multiple ways that content may be received into the digital content device 10. The content delivery technology may differ from host device to host device. For example, an internet-connected host (PC, wifi-enabled PMP, TVs) may use an online application program, such as an online video web site with aggregated content listing, making selection possible for user to subscribe to their favorite “channels.” Various formats and feeds, such as RSS and XML formats and feeds may be employed. Other host devices may utilize broadcast content if that host device has the DTV reception capability. For instance, a digital TV receiver (including set-top boxes, televisions with integrated hard disk drives, and the like) may implement its application code as a DVR function, where the linear TV content is stored not in the hard disk drive of the digital TV receiver, for example, but in the device 10 (e.g., having flash memory, hard disk memory, or other memory) which may be coupled to the TV. It should be emphasized, however, that the foregoing examples are not meant to be limiting. Moreover, as discussed, application code of the device 10 may facilitate the ingestion of content to the device 10 or the update of the content on the device 10. Again, both the library 16 and AID 18 may be updated.

Also, application code (e.g., application control 12 and host APIs 14) on the device 10 may read from the device user information, such as advertisement sale-related metadata, advertisement impression count, and other audience measurement data. In the illustrative example of FIG. 1, such data may be stored in metadata access section 20, which is provided for collecting the data. Such information may be used by the application code to customize advertisements for a particular user. Thus, over time, the advertisements within a device 10 of a particular user may be better structured to the viewing taste and habits of that user. Audience measurement information including metadata and other user information may be transmitted (e.g., from the metadata access section 20) through a host device having a back channel, for example, to content and service providers. Metadata regarding usage and advertisement inventory information may facilitate advertisement sales tracking of the user by the content and TV service providers.

In embodiments, the AID 18 and metadata access section 20 are situated in areas protected from access by the user. In one example, the AID 18 and metadata access section 20 are disposed in memory partition support areas not accessible by users. Further, content player control codes may be stored in such protected areas, along with other security-related data, such as keys and device ID, etc. As indicated, the device 10 may have a file system with a directory for the library 16 dedicated to storing and maintenance of video content. Another similarly structured directory may be dedicated to storing and maintenance of advertisements of AID 18 and the related data in metadata access section 20. Other data directories customary to a multimedia file system, and known to those skilled in the art, may also be included. The present technique may also accommodate a next-level file directory that allows the device 10 to be utilized with multiple content providers, each with its own “store front” directory comprising its own library and AID, and other beneficial data structures.

In sum, the embodiments of the present memory device and method provide for various benefits. For example, content security may be enhanced because the player software is generally resident in the memory device. Thus, there may be a security advantage because the combination of player code and content data resident on the memory device provides for content decoding to be performed without transfer of content data from the memory device to the host device. Also, consumers or users can relatively easily associate content with a physical device, and move the content among host devices (e.g., mobile phone, handheld/portable PMP, TV, PC). Further, video content may be automatically updated using multiple sources associated with the memory device. For instance, when the memory device is attached to a mobile phone with ATSC M/H datacast reception capability, the latest content downloads into the memory device. If the memory device is digitally attached to an output of a TV receiver, on-air TV shows from linear TV programs can be stored as content on the device 10. Moreover, the technique addresses interoperability of traditional playback, reducing the need to transcode and/or move the content data from one media to another. In other words, the content stays with the device 10 with beneficial in-memory execution of the playback control codes.

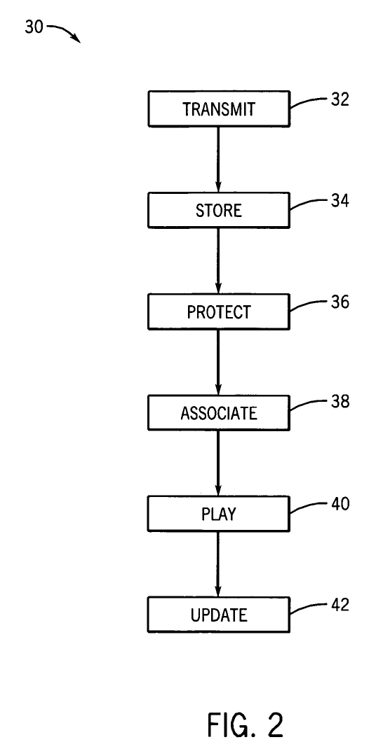

FIG. 2 depicts a method 30 of providing at least a first content (e.g., TV shows or episodes, movies, clips, etc.) and a second content (e.g., advertisements). In this example, the first content and second content are transmitted and/or downloaded to a removable memory-based device (e.g., digital content device 10 of FIG. 1), as indicated by reference numeral 32. The content may be transmitted, for example, from a service provider via a host device digitally coupled to the memory-based device. The memory-based device generally includes a known set of APIs so that the memory-based device can execute properly to send commands to the host device. The population of the content to the memory-based device 10 may be typically accomplished via an internet connection, through a TV data broadcast (e.g., via a secondary or auxiliary data channel), through a mobile phone, and so on.

The first content and second content are organized and stored on the memory-based device, as indicated by reference numeral 34. The device includes application code to control ingestion of the content. In this example, the first content and second content are stored in separate areas on the memory-based device. The second content may be stored in an area protected or partially-protected from direct access by the user, as indicated by reference numeral 36. Thus, in certain embodiments, while the user may select files of the first content for viewing, the user will generally not be able to directly select files of the second content for viewing. In another example, the user may be able to select files of the second content for viewing, but cannot delete the files, for example. On the other hand, the area of second content may not be protected and the user may have full access for viewing, deletion, and manipulation of the files. Such configurations may depend on the hardware, the associated control code, the subscription arrangement with the service provider, and so forth.

Yet, the second content is associated with the first content, as indicated by reference numeral 38. In other words, while the first content is being viewed, second content will automatically be inserted into the viewing of the first content. For example, an advertisement (second content) may be inserted at a commercial break of a TV show (first content). Such association and insertion of the second content may be managed by application control code stored and executable on the memory-based device (having solid-state memory and/or other memory). It should be noted that the second content (e.g., advertisement) selected for insertion may be variable, depending on user statistics, metadata, playback history, and the like. Such data relating to the user may be stored on the memory-based device, such as in a protected area of the device, and also transmitted back to the service provider (e.g., through the host device).

The content loaded onto the memory-based device is played for viewing by the user, as indicated by reference numeral 40. Application code for a player is generally resident and executable on the memory-based device to play the content. To play the content, the memory-based device may be digitally coupled to a host device and the content viewed at the host device. The memory-based device may function as an extension of the memory of the host device in playing the content at the host device, and also, as indicated, in receiving or transmitting content and data through the host device.

Lastly, both the first content and the second content may be updated, as indicated by reference numeral 42. For example, new episodes of a TV show may be transmitted from a service provider to the memory-based device and stored on the memory-based device as first content. Such updates may be at the request of the user, through a subscription service, and so forth. In another example, new or different advertisements may be transmitted from a service provider and/or external advertisement service to be stored on the memory-based device as second content. Such updates may be based on metadata and user statistic data, for example.

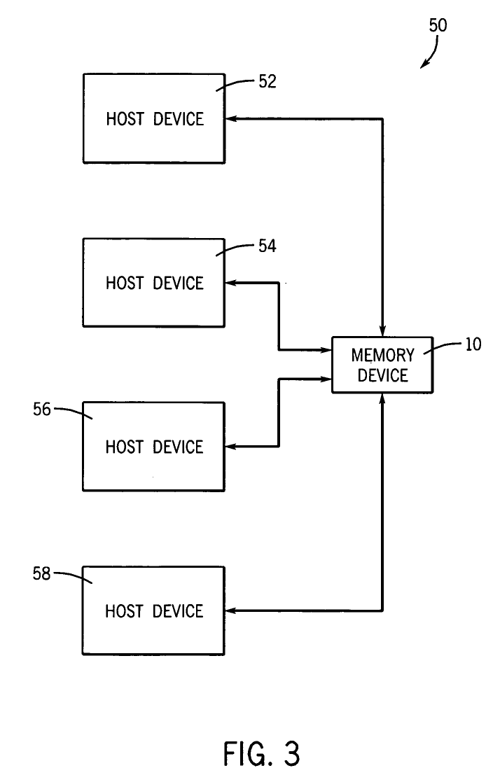

FIG. 3 depicts a diagrammatical representation 50 of a digital content device 10 (memory device) which may be coupled to a plurality of host devices. In the illustrated embodiment, the digital content device 10 is operable to couple to at least four host devices 52, 54, 56, and 58, as indicated by the directional arrows. The device 10 may be an external device that may be inserted, removed, scanned, and/or wirelessly coupled, and so on, in relation to the host devices 52, 54, 56, and 58.

As suggested, the host devices 52, 54, 56, and 58 may be the same or different type of host device, and may include a variety of devices. In one contemplated embodiment, host device 52 is a TV receiver (or set-top box) with an internet connection, host device 54 is a personal computer with an internet connection, host device 56 is a portable media player, and host device 58 is a smart phone with ATSC-MH reception. Again, however, the host devices may be other devices that may communicate with the digital content device 10. Moreover, as discussed, the digital content device 10 may act as an extension of the memory of the host devices 52, 54, 56, and 58. In addition, as should be apparent, the method 30 of FIG. 2 and other methods may be implemented in the configuration depicted in FIG. 3.

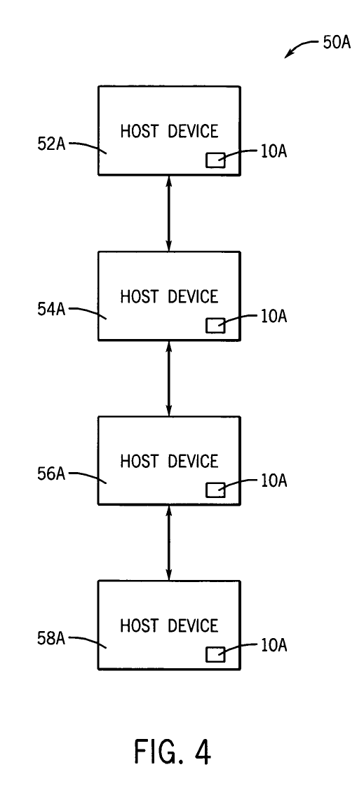

FIG. 4 depicts a diagrammatical representation 50 of a plurality of host devices 52A, 54A, 56A, and 58A, which may be the same or different type of device, each having a memory 10A. The memory 10A is configured to store and organize digital content. The memory 10A may be configured similar as the digital content device 10, but is resident in the host device. The memory 10A may be part of or coupled to other memory of the host devices 52A, 54A, 56A, and 58A. In a contemplated embodiment, the memory 10A is essentially non-removable from the host device. The memory 10A may be a hard-disk, RAM, and/or flash memory, and so on.

Further, the method 30 (and variations) of FIG. 2 may be implemented with the configuration depicted in FIG. 4. The host devices 52A, 54A, 56A, and 58A may receive digital content into memory 10A from multiple sources or service providers. As discussed, the content may be viewed at the host devices 52A, 54A, 56A, and 58A. A potential advantage is that the host device APIs may be more configurable within resident memory 10A or not be stored on memory 10A but on other memory within the host device.

In addition, in certain embodiments, the host devices 52A, 54A, 56A, and 58A may communicate with each other, such as via a wired connection (e.g., USB connection), wireless connection, (e.g., streaming over Bluetooth), and the like. Thus, digital content may be transferred from a memory 10A of one host device to a memory 10A of another host device. It should be noted that because the memory 10A need not move from one host device to the other device, these scenarios provide for the options of transfer or movement of only the first content (e.g., TV series or movies) or only the second content (e.g., advertisements). Thus, for example, the first content may be transferred from the memory 10A of host device 52A to the memory 10A of host device 54A, while the second content (e.g., advertisements) remains unchanged on the memory 10A of host device 54A. Therefore, the second content may continued to be tailored to the user of the host device 54A, for example. Lastly, it should be noted that a variety of embodiments are contemplated where, for example, a removable device 10 (see FIG. 1) may be used in conjunction with a host device having a memory 10A, and first and/or second content and other content received, transferred, and stored among the various memory.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A device for receiving, storing, and viewing digital content, the device comprising:
an interface for coupling digitally to a host device; and
a memory configured to:
receive and store a first content separate from a second content;
interact with the host device;
associate the second content with the first content; and
play the first content and the second content.

2. The device of claim 1, wherein the memory is configured to play the first content and the second content for viewing at the host device.

3. The device of claim 1, wherein the device is configured to receive the first content and the second content via the host device.

4. The device of claim 1, wherein the memory is configured to receive, store, and organize updates of the first content and of the second content.

5. The device of claim 1, wherein the memory is configured to store data associated with playback history of the first content or of the second content, or a combination thereof.

6. The device of claim 5, wherein the memory is configured to facilitate transmission of the data to a service provider.

7. The device of claim 1, wherein the memory is configured to update the second content based on the playback history of the first content.

8. The device of claim 1, wherein the memory is configured to protect access of the second content.

9. A device for receiving, storing, and viewing digital content, the device comprising:
an interface for coupling digitally to a host device;
a memory; and
a system architecture stored in the memory, wherein the system architecture configures the memory to:
receive and store a first content separate from a second content;
associate playback of the second content with playback of the first content; and
facilitate playback of the first content and the second content for viewing at the host device.

10. The device of claim 9, wherein system architecture configures the memory to receive and store an application program interface (API) of the host device to facilitate the receipt and storage of the first content and of the second content into the memory via the host device.

11. The device of claim 9, wherein system architecture comprises an application program interface (API) stored in the memory to play the first content and the second content at the host device.

12. The device of claim 9, wherein the memory is partitioned and configured such that the second content is at least partially-protected from user-access.

13. A device for receiving, storing, and organizing digital content, the device comprising:
an interface for coupling digitally to a host device;
a memory;
a first program code stored in the memory, wherein the first program code organizes receipt and storage in the memory of a first digital content and a second digital content, and organizes playback of the first digital content and of the second digital content;
a second program code stored in memory to facilitate interaction of the device with the host device; and
a third program code stored in memory to play back the first digital content and the second digital content for viewing at the host device.

14. The device of claim 13, wherein the first program code protects access of the second digital content.

15. The device of claim 13, wherein the second program faciltates ingestion of the first digital content and of the second digital content into the memory via the host device.

16. The device of claim 13, wherein the second program comprises an application program interface of the host device.

17. The device of claim 13, wherein the third program comprises a media player.

18. A method for disseminating digital content, comprising:
transmitting a first content and a second content via a host device to a memory;
storing the first content and the second content in the memory;
associating via executable code stored in the memory playback of the second content with playback of the first content;
facilitating via executable code stored in the memory playback of the first content and the second content for viewing at the host device; and
updating the first content stored in memory or the second content stored in memory, or a combination thereof.

19. The method of claim 18, comprising transmitting via executable code stored in the memory a playback history of at least the first content or the second content to a service provider.

20. The method of claim 18, comprising protecting access of the second content stored in memory.

21. A method for disseminating digital content, comprising:
providing a first content into a first partion of a memory device;
providing a second content into a second partition of the memory device, wherein the memory device is configured to facilitate playback of the first content and of the second content at one or more host devices;
associating the second content with the first content;
monitoring via executable code stored in the memory device a playback history of the first content and of the second content at the one or more host devices; and
changing the association of the second content with the first content.

22. The method of claim 21, wherein the memory comprises solid-state memory.

23. The method of claim 21, comprising transmitting the playback history to a service provider, and wherein changing the association comprises changing the association of the second content with the first content based on the playback history.

24. The method of claim 21, comprising receiving at a service provider usage statistics of the memory device.

25. The method of claim 21, wherein changing the association of the second content with the first content comprises providing additional second content into the second partion of the memory device.

26. The method of claim 21, comprising providing additional first content into the first partion of the memory device in response to a request of a user of the memory device.

27. A device for viewing digital content, comprising:
an interface to receive digital content; and
a memory configured to:
organize and store a first content separate from a second content;
associate the second content with the first content; and
organize and store updates of the first content and of the second content

28. The device of claim 27, wherein the memory comprises player code configured to play the first content and the second content at the device.

29. The device of claim 27, wherein the memory is configured to store data associated with a playback history of the first content or of the second content, or a combination thereof.

30. The device of claim 29, wherein the device and memory are configured to transmit the data to a service provider.

31. The device of claim 29, wherein the memory is configured to update the second content based on the playback history of the first content.

32. The device of claim 27, wherein the memory is configured to protect access of the second content.

33. The device of claim 27, wherein the device and memory are configured to transmit the first content or the second content, or a combination thereof, to another device.

34. A method for disseminating digital content, comprising:
transmitting a first content and a second content;
storing the first content and the second content in memory;
associating via executable code stored in the memory playback of the second content with playback of the first content;
playing via executable code stored in the memory the first content and the second content, wherein the first content is viewed with the second content based on the association; and
updating at least the first content or the second content stored in memory.

35. The method of claim 34, wherein updating comprises updating the second content stored in the memory based on a playback history of at least the first content or of the second content.

36. The method of claim 34, comprising transmitting via executable code stored in the memory the playback history to a service provider.
